(19) United States
(12) Patent Application Publication
(10) Pub. No.: US 2009/0141173 A1
(43) Pub. Date: Jun. 4, 2009

(54) Apparatus Having an Emergency Alert Function With Priority Override Feature

(76) Inventor: Michael Anthony Pugel, Noblesville, IN (US)

Correspondence Address: Robert D. Shedd;Thomson Licensing LLC, 2 Independence Way, PRINCETON, NJ, 08543-5312, US

(21) Appl. No.: 11/988,360

(22) PCT Filed: Jul. 13, 2005
(86) PCT No.: PCT/US2005/024832

§ 371 Date: Jan. 3, 2008

(51) Int. Cl. H04N 5/445; G08B 23/00

(52) U.S. Cl. 348/563; 340/500; 348/E05.099

(57) ABSTRACT

An apparatus such as a television signal receiver, radio or other apparatus provides an emergency alert function with a priority override feature to ensure that users are informed of significant emergency events. According to an exemplary embodiment, the apparatus includes a signal receiving element operative to receive emergency alert signals providing an emergency message. A processor is operatively coupled to the signal receiving element and detects if a condition associated with the emergency message exists. The processor processes the emergency alert signals in accordance with user settings for the emergency alert function if the condition does not exist. The processor overrides the user settings and enables an alert output if the condition exists.

The present invention generally relates to apparatuses such as television signal receivers, radios or other apparatuses having an emergency alert function, and more particularly, to an apparatus and method for providing an emergency alert function with a priority override feature to ensure that users are informed of significant emergency events.

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions before the general public. Through the use of modern weather detection devices, such as Doppler radar and weather satellites, the NWS and NOAA are able to issue early warnings of severe weather conditions which have saved many lives. Other authorities such as the Emergency Action Notification Network (EAN) and civil authorities also issue notifications of emergency events, including non-weather related events. Regardless of the source, for such notifications to be effective, they must be properly communicated to their intended recipients.

Certain apparatuses are capable of receiving emergency alert signals provided by sources such as the NWS, NOAA, and EAN, and provide an emergency alert function using Specific Area Message Encoding (SAME) technology. Apparatuses using SAME technology typically require a user to perform a setup process for the emergency alert function by selecting items such as one or more channels which are monitored in order to receive emergency alert signals, one or more geographical locations of interest, and one or more types of emergency events which activate the emergency alert function. Once the setup process is complete, the emergency alert function may be activated when incoming emergency alert signals including SAME data indicate the occurrence of an emergency event which corresponds to the geographical location(s) and type(s) of emergency events selected by the user during the setup process. When the emergency alert function is activated, an alert output such as an audio and/or visual message may be provided to inform individuals of the emergency event.

With apparatuses having an emergency alert function using technology such as SAME technology, problems may arise based on a user's selections in the aforementioned setup process. As previously indicated, the setup process typically requires a user to select one or more types of emergency events which activate the emergency alert function. However, users may not select emergency events they do not understand. For example, an emergency event such as Emergency Action Notification may be provided as a user option during the setup process. Since the event name itself provides little indication of what this event refers to, users may not understand this event, and therefore may not select it as an event which activates the emergency alert function. However, this event is very significant since it would occur if, for example, the United States was under attack or going to war. Therefore, by not selecting such significant emergency events during the setup process, users may not be informed if those events actually occur.

Accordingly, there is a need for an apparatus and method for providing an emergency alert function that avoids the foregoing problems, and thereby provides a priority override feature to ensure that users are informed of significant emergency events. The present invention addresses these and/or other issues.

In accordance with an aspect of the present invention, an apparatus having an emergency alert function is disclosed. According to an exemplary embodiment, the apparatus comprises means for receiving emergency alert signals providing an emergency message, and processing means for detecting if a condition associated with the emergency message exists. The processing means processes the emergency alert signals in accordance with user settings for the emergency alert function if the condition does not exist. The processing means overrides the user settings and enables an alert output if the condition exists.

In accordance with another aspect of the present invention, a method for providing an emergency alert function is disclosed. According to an exemplary embodiment, the method comprises receiving emergency alert signals providing an emergency message, detecting if a condition associated with the emergency message exists, processing the emergency alert signals in accordance with user settings for the emergency alert function if the condition does not exist, and overriding the user settings and providing an alert output if the condition exists.

In accordance with another aspect of the present invention, a television signal receiver having an emergency alert function is disclosed. According to an exemplary embodiment, the television signal receiver comprises a signal receiving element operative to receive emergency alert signals providing an emergency message. A processor is operatively coupled to the signal receiving element and detects if a condition associated with the emergency message exists. The processor processes the emergency alert signals in accordance with user settings for the emergency alert function if the condition does not exist. The processor overrides the user settings and enables an alert output if the condition exists.

The above-mentioned and other features and advantages of this invention, and the manner of attaining them, will become more apparent and the invention will be better understood by reference to the following description of embodiments of the invention taken in conjunction with the accompanying drawings, wherein:

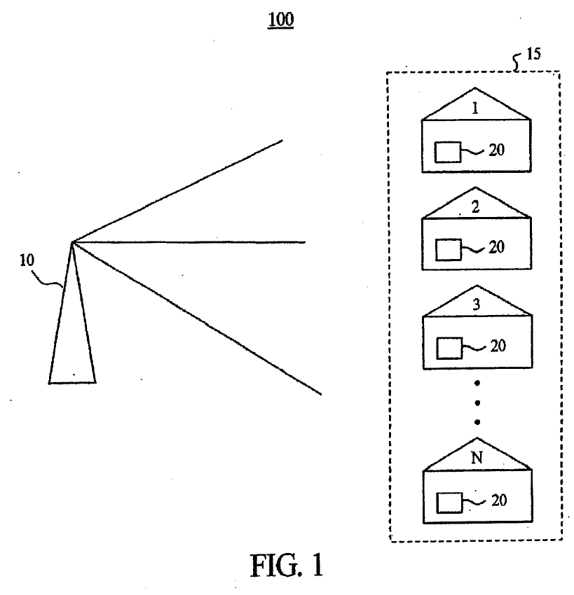

FIG. 1 is an exemplary environment suitable for implementing the present invention;

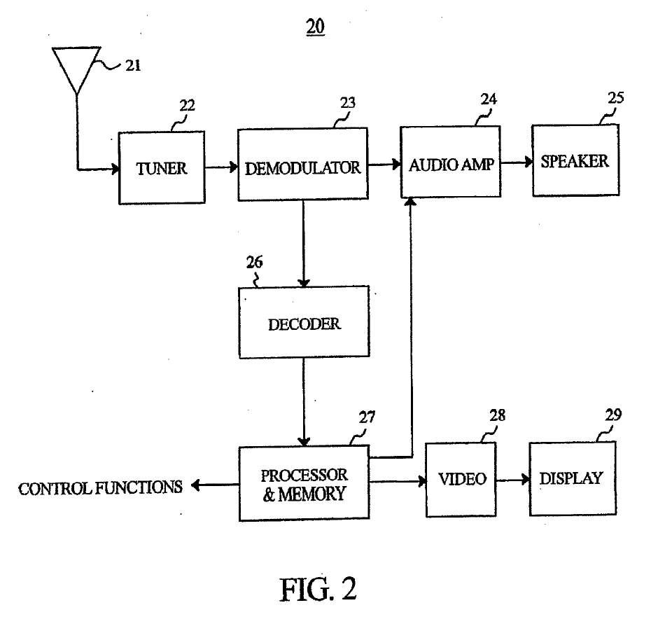

FIG. 2 is a block diagram of an apparatus having an emergency alert function according to an exemplary embodiment of the present invention;

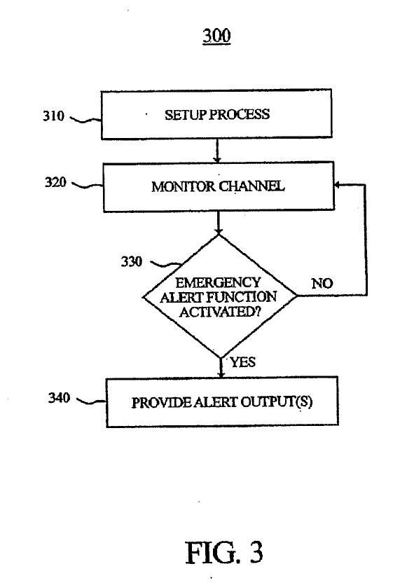

FIG. 3 is a flowchart illustrating exemplary steps for providing an emergency alert function; and

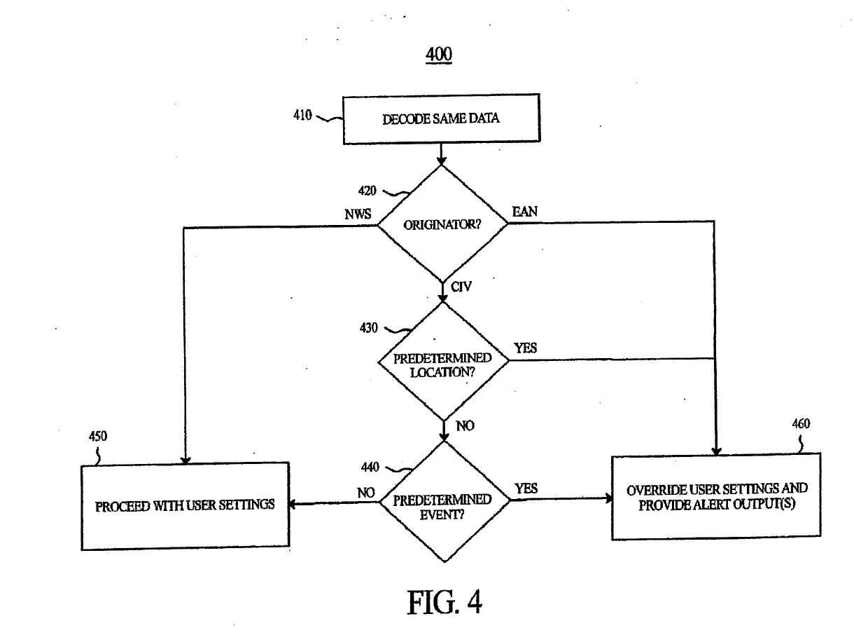

FIG. 4 is a flowchart illustrating steps for providing a priority override feature for an emergency alert function according to an exemplary embodiment of the present invention.

The exemplifications set out herein illustrate preferred embodiments of the invention, and such exemplifications are not to be construed as limiting the scope of the invention in any manner.

Referring now to the drawings, and more particularly to FIG. 1, an exemplary environment 100 suitable for implementing the present invention is shown. In FIG. 1, environment 100 comprises signal transmission means such as signal transmission source 10, dwelling means such as dwelling units 15 (i.e., 1, 2, 3 . . . N, where N may be any positive integer), and signal receiving means such as apparatuses 20.

In FIG. 1, dwelling units 15 may represent residences, businesses and/or other dwelling places located within a particular geographical location, such as but not limited to, a particular continent, country, region, state, area code, zip code, city, county, municipality, subdivision, and/or other definable geographical location. According to an exemplary embodiment, each of the dwelling units 15 is equipped with at least one apparatus 20 having an emergency alert function. Apparatus 20 may be embodied as any type of apparatus having an emergency alert function such as a television signal receiver, radio, or other apparatus. According to the present invention, the emergency alert function enables, among other things, apparatus 20 to receive emergency alert signals and provide one or more alert outputs to notify individuals of emergency events.

According to an exemplary embodiment, signal transmission source 10 transmits signals including audio, video and/or emergency alert signals which may be received by each apparatus 20. According to an exemplary embodiment, the emergency alert signals may be provided from an authority such as the NWS, and/or other authorities such as governmental entities or the like. Signal transmission source 10 may transmit the emergency alert signals in their original form as provided by the authority, or may append digital data representative of the emergency alert signals to other data, or may modify the emergency alert signals in some manner appropriate for its specific transmission format needs. In response to the emergency alert signals, each apparatus 20 may provide one or more alert outputs to thereby notify individuals of the emergency event. Signal transmission source 10 may transmit signals to television signal receivers 20 via any wired or wireless link such as, but not limited to, terrestrial, cable, satellite, fiber optic, digital subscriber line (DSL), and/or any other type of broadcast and/or multicast means.

Referring to FIG. 2, a block diagram of an exemplary embodiment of apparatus 20 of FIG. 1 is shown. In FIG. 2, apparatus 20 comprises signal receiving means such as signal receiving element 21, tuning means such as tuner 22, demodulation means such as demodulator 23, audio amplification means such as audio amplifier 24, audio output means such as speaker 25, decoding means such as decoder 26, processing means and memory means such as processor and memory 27, video processing means such as video processor 28, and visual output means such as display 29. Some of the foregoing elements may for example be embodied using integrated circuits (ICs). For clarity of description, certain conventional elements associated with apparatus 20 such as certain control signals, power signals and/or other elements may not be shown in FIG. 2.

Signal receiving element 21 is operative to receive signals including audio, video and/or emergency alert signals from signal sources, such as signal transmission source 10 in FIG. 1. According to an exemplary embodiment, received audio signals may include digitally encoded emergency alert signals. According to another exemplary embodiment, emergency alert signals may be received as separate data packets in a digital transmission system. Signal receiving element 21 may be embodied as any signal receiving element such as an antenna, input terminal or other element.

Tuner 22 is operative to tune signals including audio, video and/or emergency alert signals. According to an exemplary embodiment, tuner 22 may be capable of tuning audio signals on at least the following designated NWS frequencies: 162.400 MHz, 162.425 MHz, 162.450 MHz, 162.475 MHz, 162.500 MHz, 162.525 MHz and 162.550 MHz. As previously indicated herein, such audio signals may include digitally encoded emergency alert signals. Tuner 22 may also tune other channels including those used in terrestrial, cable, satellite and/or other transmissions.

Demodulator 23 is operative to demodulate signals provided from tuner 22, and may demodulate signals in analog and/or digital transmission formats. According to an exemplary embodiment, demodulator 23 demodulates audio signals to thereby generate demodulated audio signals representing audio content such as an NWS audio message, a warning alert tone (e.g., siren, alarm, etc.) and/or other audio content. Audio amplifier 24 is operative to amplify the audio signals output from demodulator 23 responsive to one or more control signals provided from processor 27. Speaker 25 is operative to aurally output the amplified audio signals provided from audio amplifier 24.

Decoder 26 is operative to decode signals including audio, video and/or emergency alert signals. According to an exemplary embodiment, decoder 26 decodes audio signals to thereby extract digitally encoded frequency shift keyed (FSK) signals, which represent emergency alert signals indicating an emergency event. Decoder 27 may also perform other decoding functions, such as decoding data which represents emergency alert signals included in the vertical blanking interval (VBI) of an analog television signal.

According to an exemplary embodiment, the emergency alert signals include SAME data associated with the emergency event. SAME data comprises a digital code representing an emergency message. SAME data includes various information about an emergency event, including where the emergency message originated, the specific geographical location(s) affected by the emergency event, and the type of emergency event (e.g., tornado watch, radiological hazard warning, civil emergency, emergency action notification, etc.). SAME data is used by the NWS, the EAN and other authorities to improve the specificity of emergency alerts and to decrease the frequency of false alerts. Other data and information may also be included in the emergency alert signals according to the present invention.

Processor and memory 27 are operative to perform various processing and data storage functions of apparatus 20. According to an exemplary embodiment, processor 27 receives the emergency alert signals from decoder 26 and determines whether the emergency alert function of apparatus 20 is activated based on data included in the emergency alert signals. According to this exemplary embodiment, processor 27 compares data in the emergency alert signals to user setup data stored in memory 27 to determine whether the emergency alert function is activated. As will be described later herein, a setup process for the emergency alert function of apparatus 20 allows a user to select items such as an applicable geographical location(s), and type(s) of emergency events (e.g., tornado watch, radiological hazard warning, civil emergency, etc.) which activate the emergency alert function.

When the emergency alert function of apparatus 20 is activated, processor 27 outputs one or more control signals which enable various operations. According to an exemplary embodiment, such control signals enable one or more alert outputs (e.g., aural and/or visual) to thereby notify individuals of the emergency event. Such control signals may also enable other operations of apparatus 20, such as causing it to be switched from an off/standby mode to an on mode.

Processor 27 is also operative to enable other operations associated with the emergency alert function of apparatus 20. According to the present invention, processor 27 is operative to enable a priority override feature of the emergency alert function. According to an exemplary embodiment, processor 27 enables the priority override feature by detecting if a predetermined condition associated with a received emergency message exists. This predetermined condition may, for example, include the emergency message originating from a predetermined source, the emergency message being applicable to a predetermined location, and/or the emergency message indicating an occurrence of a predetermined emergency event. According to this exemplary embodiment, processor 27 processes received emergency alert signals in accordance with user settings for the emergency alert function if the predetermined condition does not exist. Processor 27 overrides the user settings and enables an alert output if the predetermined condition exists. Further details regarding these aspects of the present invention will be provided later herein.

Video processor 28 is operative to process signals including video signals. According to an exemplary embodiment, such video signals may include embedded messages such as NWS text messages and/or other messages that provide details regarding emergency events. Video processor 28 may include closed caption circuitry which enables closed caption displays.

Display 29 is operative to provide visual displays. According to an exemplary embodiment, display 29 may provide visual displays including the aforementioned messages that provide details regarding emergency events. Display 29 may also include a viewable display panel having one or more indicator elements such as light emitting diodes (LEDs), liquid crystal display (LCD) elements, liquid quartz display (LQD) elements, and/or other elements. Such indicator elements may include highlighted indicators, such as monochrome and/or colored indicators, plasma display indicators, and/or conventional lights used as consumer electronic product indicators, and may for example reside apart from apparatus 20, such as on a portable (e.g., non-tethered) lighted panel designed for a wall and/or desk display. This may also allow various LED, LCD, LQD, plasma and/or cathode ray tube (CRT) devices to incorporate indicator elements for the emergency alert function as the total visual data field or a portion thereof. For example, the indicator elements may be highlighted as a portion of the visual data being displayed on an LCD panel playing recorded video content, such as content from a digital versatile disk (DVD) or the like.

Turning now to FIG. 3, a flowchart 300 illustrating exemplary steps for providing an emergency alert function is shown. For purposes of example and explanation, the steps of FIG. 3 will be described with reference to apparatus 20 of FIG. 2. The steps of FIG. 3 are merely exemplary, and are not intended to limit the present invention in any manner.

At step 310, a setup process for the emergency alert function of apparatus 20 is performed. According to an exemplary embodiment, a user performs this setup process by providing inputs to apparatus 20 (e.g., using a remote control device not shown) responsive to an on-screen menu displayed via display 29. According to an exemplary embodiment, the user may select at least the following items during the setup process at step 310:

A. Enable/Disable—The user may select whether to enable or disable the emergency alert function.
B. Monitoring Channel(s)—The user may select one or more channels that are monitored in order to receive emergency alert signals. For example, the user may select channels corresponding to one or more of the following NWS transmission frequencies: 162.400 MHz, 162.425 MHz, 162.450 MHz, 162.475 MHz, 162.500 MHz, 162.525 MHz and 162.550 MHz. Channels may be manually selected by the user, or may be selected using an auto-tune mode which automatically tunes all of the channels associated with the emergency alert function to thereby identify one or more channels that provide the highest signal strength.
C. Geographical Locations—The user may select one or more geographical locations of interest. For example, the user may select a particular continent, country, region, state, area code, zip code, city, county, municipality, subdivision, and/or other definable geographical location. Such geographical location(s) may be represented by location codes, such as Federal Information Processing Standard (FIPS) location codes.
D. Event Types—The user may select one or more types of emergency events which activate the emergency alert function. For example, the user may designate that events such as civil emergencies, radiological hazard warnings, and/or tornado warnings activate the emergency alert function, but that events such as a thunderstorm watch does not, etc. The user may also select whether the conventional warning audio tone provided by the NWS and/or other alert mechanism activates the emergency alert function. According to the present invention, different severity or alert levels (e.g., statement, watch, warning, etc.) may represent different “events.” For example, a thunderstorm watch may be considered a different event from a thunderstorm warning.
E. Alert Outputs—The user may select one or more alert outputs to be provided when the emergency alert function is activated. According to an exemplary embodiment, the user may select visual and/or aural outputs to be provided for each type of emergency event that activates the emergency alert function. For example, the user may select to display a visual message (e.g., an NWS text message as a closed caption display) and/or tune apparatus 20 to a specific channel. The user may also for example select to aurally output a warning tone (e.g., alarm, siren, etc.) and/or an audio message (e.g., NWS audio message), and the desired volume of each. Other types of alert outputs may also be provided according to the present invention.

According to the present invention, other menu selections may also be provided at step 310 and/or some of the menu selections described above may be omitted. Data corresponding to the user's selections during the setup process of step 310 is stored in memory 27.

At step 320, apparatus 20 monitors the channel(s) selected by the user during the setup process of step 310 (i.e., item B) for emergency alert signals. According to an exemplary embodiment, tuner 22 monitors the selected channel(s) and thereby receives incoming emergency alert signals. According to the present invention, apparatus 20 is capable of monitoring channels and receiving emergency alert signals during all modes of operation, including for example when apparatus 20 is turned on, turned off, and/or during playback of recorded audio and/or video content.

At step 330, a determination is made as to whether the emergency alert function of apparatus 20 is activated. According to an exemplary embodiment, processor 27 makes this determination by comparing data included in the incoming emergency alert signals to data stored in memory 27. As previously indicated herein, the emergency alert signals may include data such as SAME data which represents information including the type of emergency event (e.g., tornado watch, radiological hazard warning, civil emergency, etc.) and the specific geographical location(s) affected by the emergency event. According to an exemplary embodiment, processor 27 compares this SAME data to corresponding user setup data (i.e., items C and D of step 310) stored in memory 27 to thereby determine whether the emergency alert function is activated. In this manner, the emergency alert function of apparatus 20 is activated when the emergency event indicated by the emergency alert signals corresponds to: (1) any geographical location(s) selected by the user at item C of step 310 and (2) any event type(s) selected by the user at item D of step 310.

If the determination at step 330 is negative, process flow loops back to step 320 where tuner 22 continues to monitor the selected channel(s). Alternatively, if the determination at step 330 is positive, process flow advances to step 340 where apparatus 20 provides one or more alert outputs to thereby notify individuals of the emergency event.

According to an exemplary embodiment, processor 27 enables the one or more alert outputs at step 340 in accordance with the user's selections during the setup process of step 310 (i.e., item E), and such alert outputs may be aural and/or visual in nature. For example, aural outputs such as a warning tone (e.g., siren, alarm, etc.) and/or an NWS audio message may be provided at step 340 via speaker 25, and the volume of such aural outputs may be controlled in accordance with the volume level set by the user during the setup process of step 310. Visual outputs may also be provided at step 340 via display 29 to notify individuals of the emergency event. According to an exemplary embodiment, an auxiliary information display such as an NWS text message (e.g., as a closed caption display) and/or a video output from a specific channel may be provided at step 340 via display 29 under the control of processor 27.

According to another exemplary embodiment, the alert output(s) provided at step 340 may be based on the severity or alert level of the particular emergency event. For example, emergency events may be classified in one of three different alert level categories, such as statement, watch, and warning. With such a classification scheme, the alert output for an emergency event at a level 1 or advisory level may be provided by an unobtrusive notification means such as a blinking LED since it is the least severe type of emergency event. The alert output for an emergency event at a level 2 or watch level may have some type of audio component (e.g., radio message). The alert output for an emergency event at a level 3 or warning level may be provided by a siren or other type of alarm since it is the most severe type of emergency event. Other types of aural and/or visual alert outputs than those expressly described herein may also be provided according to the present invention.

Turning now to FIG. 4, a flowchart 400 illustrating steps for providing a priority override feature for an emergency alert function according to an exemplary embodiment of the present invention is shown. For purposes of example and explanation, the steps of FIG. 4 will also be described with reference to apparatus 20 of FIG. 2. The steps of FIG. 4 are merely exemplary, and are not intended to limit the present invention in any manner.

At step 410, apparatus 20 receives emergency alert signals including SAME data and decodes the SAME data. According to an exemplary embodiment, decoder 26 decodes the SAME data at step 410, which is then provided to processor 27. As previously indicated herein, SAME data comprises a digital code representing an emergency message. SAME data includes various information about an emergency event, including where the emergency message originated, the specific geographical location(s) affected by the emergency event, and the type of emergency event.

At step 420, processor 27 processes the SAME data provided from decoder 26 to thereby identify a source from which the emergency message originated. According to an exemplary embodiment, the emergency message represented by the SAME data may originate from various different places such as the NWS, the EAN, or civil authorities. If processor 27 determines at step 420 that the emergency message originated from the NWS, process flow advances to step 450 where processor 27 processes the SAME data in accordance with the user settings established at step 310 of FIG. 3. That is, processor 27 compares the SAME data to the user setup data stored in memory 27 to determine whether the emergency alert function of apparatus 20 is activated. In this manner, the emergency alert function of apparatus 20 is activated when the emergency event indicated by the SAME data corresponds to: (1) any geographical location(s) selected by the user at item C of step 310 and (2) any event type(s) selected by the user at item D of step 310.

Alternatively, if processor 27 determines at step 420 that the emergency message originated from the EAN, process flow advances to step 460 where processor 27 overrides the user settings established at step 310 of FIG. 3, and provides one or more alert outputs to notify individuals of the emergency event. According to an exemplary embodiment, the one or more alert outputs provided at step 460 include an audible alarm or siren to increase the likelihood that users are notified of the emergency event.

Alternatively still, if processor 27 determines at step 420 that the emergency message originated from a civil authority (CIV), process flow advances to step 430 where processor 27 then determines from the SAME data whether the emergency message is applicable to a predetermined location. According to an exemplary embodiment, this predetermined location includes an entire country (e.g., the entire United States), although other predetermined locations such as entire state or other definable location may also be used for the determination at step 430.

If processor 27 determines at step 430 that the emergency message applies to the predetermined location, process flow advances to step 460 where processor 27 overrides the user settings established at step 310 of FIG. 3, and provides one or more alert outputs to notify individuals of the emergency event, as previously described above. Alternatively, if processor 27 determines at step 430 that the emergency message does not apply to the predetermined location, process flow advances to step 440 where processor 27 then determines whether the emergency message indicates an occurrence of a predetermined emergency event. According to an exemplary embodiment, there are multiple different emergency events that may be considered a predetermined event at step 440. For example, emergency events such as an Emergency Action Notification, a National Hazard Warning, a Civil Action Emergency, an Immediate Evacuation Warning, and/or other events may be considered a predetermined event at step 440. In general, a predetermined event at step 440 may be any emergency event of which users should be immediately notified.

If processor 27 determines at step 440 that the emergency message indicates an occurrence of a predetermined emergency event, then process flow advances to step 460 where processor 27 overrides the user settings established at step 310 of FIG. 3, and provides one or more alert outputs to notify individuals of the emergency event, as previously described above. Alternatively, if processor 27 determines at step 440 that the emergency message does not indicate an occurrence of a predetermined emergency event, then process flow advances to step 450 where processor 27 processes the SAME data in accordance with the user settings established at step 310 of FIG. 3, and thereby determines whether the emergency alert function of apparatus 20 is activated, as previously described herein.

The steps of FIG. 4 are exemplary only, and may be modified in any suitable manner by those skilled in the art. For example, step 420 may be modified to accommodate emergency messages that originate from sources other than the NWS, the EAN, or a civil authority. Also, the order of steps 420 to 440 may be modified in any suitable manner as a matter of design choice. Moreover, the conditions set forth in steps 420 to 440 may be considered alone, or in other combinations, to determine whether to override the user settings for the emergency alert function. Other modifications of the steps of FIG. 4 may also be within the scope of the claimed invention.

As described herein, the present invention provides an apparatus and method for providing an emergency alert function with a priority override feature to ensure that users are informed of significant emergency events. The present invention may be applicable to various apparatuses, either with or without an integrated display device. Accordingly, the phrase “television signal receiver” as used herein may refer to systems or apparatuses including, but not limited to, television sets, computers or monitors that include an integrated display device, and systems or apparatuses such as set-top boxes, video cassette recorders (VCRs), digital versatile disk (DVD) players, video game boxes, personal video recorders (PVRs), computers or other apparatuses that may not include an integrated display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus having an emergency alert function, comprising:
means for receiving emergency alert signals providing an emergency message;
processing means for detecting if a condition associated with said emergency message exists;
said processing means processing said emergency alert signals in accordance with user settings for said emergency alert function if said condition does not exist; and
said processing means overriding said user settings and enabling an alert output if said condition exists.

2. The apparatus of claim 1, wherein said condition includes said emergency message originating from a first source.

3. The apparatus of claim 2, wherein said first source is not a weather-related source.

4. The apparatus of claim 1, wherein said condition includes said emergency message being applicable to a first location.

5. The apparatus of claim 4, wherein said first location includes an entire country.

6. The apparatus of claim 1, wherein said condition includes said emergency message indicating an occurrence of a first emergency event.

7. The apparatus of claim 1, wherein said alert output includes an audible alarm.

8. A method for providing an emergency alert function, comprising:
receiving emergency alert signals providing an emergency message;
detecting if a condition associated with said emergency message exists;
processing said emergency alert signals in accordance with user settings for said emergency alert function if said condition does not exist; and
overriding said user settings and providing an alert output if said condition exists.

9. The method of claim 8, wherein said condition includes said emergency message originating from a first source.

10. The method of claim 9, wherein said first source is not a weather-related source.

11. The method of claim 8, wherein said condition includes said emergency message being applicable to a first location.

12. The method of claim 11, wherein said first location includes an entire country.

13. The method of claim 8, wherein said condition includes said emergency message indicating an occurrence of a first emergency event.

14. The method of claim 8, wherein said alert output includes an audible alarm.

15. A television signal receiver having an emergency alert function, comprising:
a signal receiving element operative to receive emergency alert signals providing an emergency message;
a processor operatively coupled to said signal receiving element, said processor detecting if a condition associated with said emergency message exists;
said processor processing said emergency alert signals in accordance with user settings for said emergency alert function if said condition does not exist; and
said processor overriding said user settings and enabling an alert output if said condition exists.

16. The television signal receiver of claim 15, wherein said condition includes said emergency message originating from a first source.

17. The television signal receiver of claim 16, wherein said first source is not a weather-related source.

18. The television signal receiver of claim 15, wherein said condition includes said emergency message being applicable to a first location.

19. The television signal receiver of claim 18, wherein said first location includes an entire country.

20. The television signal receiver of claim 15, wherein said condition includes said emergency message indicating an occurrence of a first emergency event.
